(19) United States
(12) Patent Application Publication
(10) Pub. No.: US 2026/0362203 A1
(43) Pub. Date: Nov. 12, 2026

(54) ADAPTIVE REPORTING FOR TYPE-A AND TYPE-B POSITIONING MEASUREMENT IN AIML FRAMEWORK

(71) Applicant: Nokia Technologies Oy, Espoo (FI)

(72) Inventors: Dileep KUMAR, Espoo (FI); Muhammad Ikram ASHRAF, Espoo (FI); Gilsoo LEE, Naperville, IL (US); Fahad SYED MUHAMMAD, Massy (FR)

(21) Appl. No.: 19/653,657

(22) Filed: Apr. 21, 2026

Related U.S. Application Data
(60) Provisional application No. 63/802,699, filed on May 9, 2025.

(51) Int. Cl. H04W 24/10; H04L 5/00; H04W 64/00

(52) U.S. Cl. CPC H04W 24/10; H04L 5/0051; H04W 64/00

(57) ABSTRACT

A network apparatus caused at least to perform: receiving, from a Location Management Function (LMF), at least one of a path-based configuration or a sample-based configuration for determining positioning measurements to be used by an Artificial Intelligence/Machine Learning functionality; receiving, from a user equipment, a Sounding Reference Signal (SRS); performing the positioning measurements based on the SRS; generating a measurement report based on the positioning measurements; and transmitting to the LMF, the measurement report.

### CROSS-REFERENCE TO RELATED APPLICATION

This application claims priority from, and the benefit of, U.S. Provisional Application No. 63/802,699, filed May 9, 2025, the contents of which are hereby incorporated by reference in their entirety.

### FIELD

Various example embodiments relate generally to Artificial Intelligence/Machine Learning (AIML)-based positioning, and in particular, to adaptive, autonomous path-based and sample-based reporting for determining location coordinates.

### BACKGROUND

Wireless networking provides significant advantages for user mobility. A user's ability to remain connected while on the move provides advantages not only for the user, but also provides greater efficiency and productivity for society as a whole. As expectations for connection reliability, data speed, and lower power consumption, become more demanding, technology for wireless networking must also keep pace with such expectations. Accordingly, there is continuing interest in improving wireless networking technology.

Accurate positioning in wireless communication systems, such as 5G networks, relies on detecting a first signal path and effectively handling multi-path components. Conventional reporting methods may result in significant signaling overhead and increased power consumption, often without resulting in improved positioning accuracy, when key signal paths are already identifiable. Therefore, there is interest in an adaptive reporting solution that balances accuracy and efficiency.

### SUMMARY

According to some aspects, there is provided the subject matter of the independent claims. Some further aspects are defined in the dependent claims.

### BRIEF DESCRIPTION OF THE DRAWINGS

Some example embodiments will now be described with reference to the accompanying drawings.

FIG. 1 is a diagram of an example embodiment of wireless networking between a network system and a user equipment (UE), according to one illustrated aspect of the disclosure;

FIG. 2 is a diagram of example components of a network system, according to one illustrated aspect of the disclosure;

FIG. 3 is a diagram of an example of operations for transmitting a Sounding Reference Signal (SRS) by a UE, performing positioning measurements from the SRS by a network node, and reporting the positioning measurements to a Location Management Function (LMF), according to one illustrated aspect of the disclosure;

FIG. 4 is a diagram of an example of operations for transmitting a Positioning Reference Signal (PRS) by a network node, performing positioning measurements from the PRS by a UE, and reporting the positioning measurements to an LMF, according to one illustrated aspect of the disclosure;

FIG. 5 is a chart showing an example in which path-based reporting is determined to be used by a reporting entity, according to one illustrated aspect of the disclosure;

FIG. 6 is a chart showing an example in which sample-based reporting is determined to be used by a reporting entity, according to one illustrated aspect of the disclosure; and

FIG. 7 is a diagram of an example block diagram of a UE or a radio access network node (e.g., a gNB), according to one illustrated aspect of the disclosure.

### DETAILED DESCRIPTION

The present disclosure relates to a reporting mode by which a reporting entity, for example, a network node such as a gNodeB (gNB) or Transmission Reception Point (TRP), or a user equipment (UE), may adaptively choose between a path-based power/delay reporting or a sample-based power/delay reporting. The reporting entity may indicate a path-based power/delay reporting or a sample-based power/delay reporting based on network configurations, threshold indications, and measurements such as positioning measurements. Based on a report of the selection and/or measurements, an Artificial Intelligence/Machine Learning (AI/ML) functionality at an LMF may then determine location coordinates. By the present disclosure, the reporting mode indication from the reporting entity will allow the LMF to accurately interpret the report and reconstruct all measured samples, ensuring a balance between reporting efficiency and positioning accuracy.

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures associated with transmitters, receivers, or transceivers have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

Embodiments described in the present disclosure may be implemented in wireless networking apparatuses, such as, without limitation, apparatuses utilizing Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, enhanced LTE (eLTE), 5G New Radio (5G NR), 5G Advance, 6G (and beyond) and 802.11ax (Wi-Fi 6), among other wireless networking systems. The term ‘eLTE’ here denotes the LTE evolution that connects to a 5G core. LTE is also known as evolved UMTS terrestrial radio access (EUTRA) or as evolved UMTS terrestrial radio access network (EUTRAN).

The present disclosure may use the term “serving network device” to refer to a network node or network device (or a portion thereof) that services a UE. As used herein, the terms “transmit toward,” “transmit to,” “receive from,” and “cooperate with,” (and their variations) include communications that may or may not involve communications through one or more intermediate devices or nodes. The term “acquire” (and its variations) includes acquiring in the first instance or reacquiring after the first instance. The term “connection” may mean a physical connection or a logical connection.

The present disclosure uses 5G NR as an example of a wireless network and may use smartphones and/or extended reality headsets as an example of UEs. It is intended and shall be understood that such examples are merely illustrative, and the present disclosure is applicable to other wireless networks and user equipment.

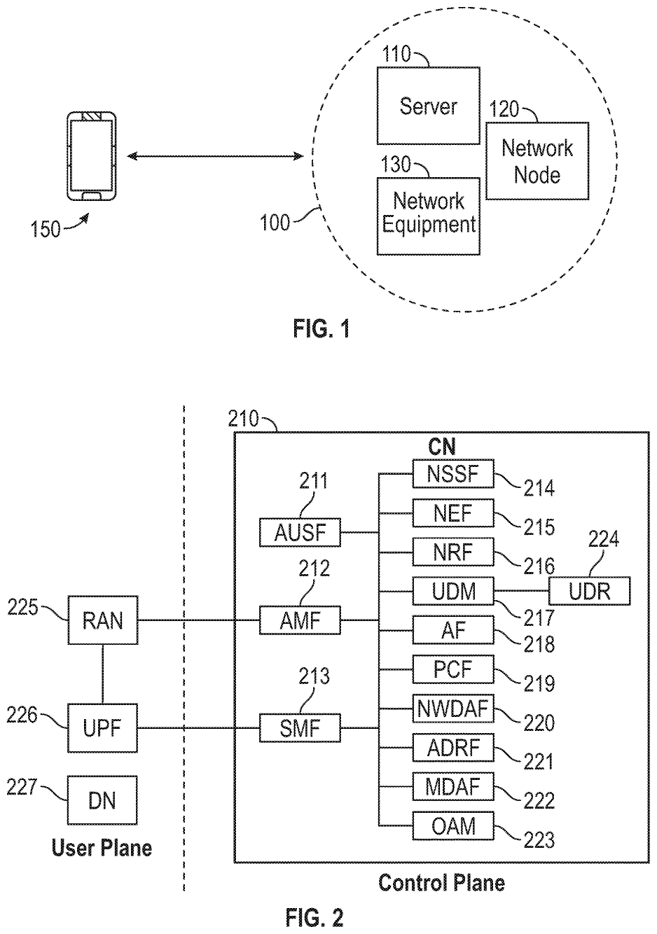

FIG. 1 is a diagram depicting an example of wireless networking between a network system 100 and a user equipment (UE) 150. The network system 100 may include one or more network nodes 120, one or more servers 110, and/or one or more network equipment 130 (e.g., test equipment). The network nodes 120 will be described in more detail below. As used herein, the term “network apparatus” may refer to any component of the network system 100, such as the server 110, the network node 120, the network equipment 130, any component(s) of the foregoing, and/or any other component(s) of the network system 100. Examples of network apparatuses include, without limitation, apparatuses implementing aspects of 5G NR, among others. The present disclosure describes embodiments related to 5G NR and embodiments that involve aspects defined by 3rd Generation Partnership Project (3GPP). However, it is contemplated that embodiments relating to other wireless networking technologies are encompassed within the scope of the present disclosure.

The following description provides further details of examples of network nodes. In a 5G NR network, a gNodeB (also known as gNB) may include, e.g., a node that provides new radio (NR) user plane and control plane protocol terminations towards the UE and that is connected via a NG interface to the 5G core (5GC), e.g., according to 3GPP TS 38.300 V16.6.0 (2021 June) section 3.2, which is hereby incorporated by reference herein.

A gNB supports various protocol layers, e.g., Layer 1 (L1)—physical layer, Layer 2 (L2), and Layer 3 (L3).

The layer 2 (L2) of NR is split into the following sublayers: Medium Access Control (MAC), Radio Link Control (RLC), Packet Data Convergence Protocol (PDCP) and Service Data Adaptation Protocol (SDAP), where, e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC quality of service (QoS) flows;
Control channels include broadcast control channel (BCCH) and physical control channel (PCCH).

Layer 3 (L3) includes, e.g., radio resource control (RRC), e.g., according to 3GPP TS 38.300 V16.6.0 (2021 June) section 6, which is hereby incorporated by reference herein.

A gNB central unit (gNB-CU) includes, e.g., a logical node hosting, e.g., radio resource control (RRC), service data adaptation protocol (SDAP), and packet data convergence protocol (PDCP) protocols of the gNB or RRC and PDCP protocols of the en-gNB, that controls the operation of one or more gNB distributed units (gNB-DUs). The gNB-CU terminates the F1 interface connected with the gNB-DU. A gNB-CU may also be referred to herein as a CU, a central unit, a centralized unit, or a control unit.

A gNB Distributed Unit (gNB-DU) includes, e.g., a logical node hosting, e.g., radio link control (RLC), media access control (MAC), and physical (PHY) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU. A gNB-DU may also be referred to herein as DU or a distributed unit.

A gNB-CU-Control Plane (gNB-CU-CP) includes, e.g., a logical node hosting, e.g., the RRC and the control plane part of the PDCP protocol of the gNB-CU for an en-gNB or a gNB. The gNB-CU-CP terminates the E1 interface connected with the gNB-CU-User Plane (gNB-CU-UP) and the F1-C interface connected with the gNB-DU.

A gNB-CU-User Plane (gNB-CU-UP) includes, e.g., a logical node hosting, e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021 July) section 3.1, which is hereby incorporated by reference herein.

As used herein, the term “network node” may refer to any of a gNB, a gNB-CU, a gNB-DU, a gNB-CU-CP, or a gNB-CU-UP, or any combination of them.

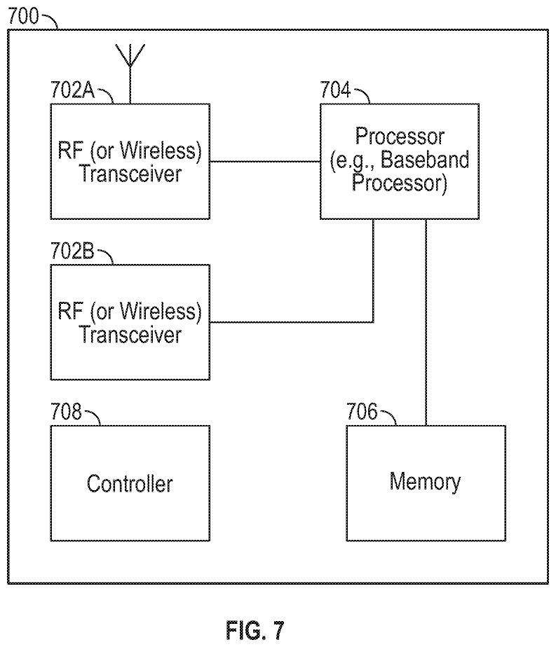

A RAN (radio access network) node or network node such as, e.g., a gNB, gNB-CU, or gNB-DU, or parts thereof, may be implemented using, e.g., an apparatus with at least one processor and/or at least one memory with processor-readable instructions (“program”) configured to support and/or provision and/or process CU and/or DU related functionality and/or features, and/or at least one protocol (sub-)layer of a RAN (radio access network), e.g., layer 2 and/or layer 3. Different functional splits between the central and distributed unit are possible. An example of such an apparatus and components will be described in connection with FIG. 7 below.

The gNB-CU and gNB-DU parts may, e.g., be co-located or physically separated. The gNB-DU may even be split further, e.g., into two parts, e.g., one including processing equipment and one including an antenna. A central unit (CU) may also be called baseband unit/radio equipment controller/cloud-RAN/virtual-RAN (BBU/REC/C-RAN/V-RAN), open-RAN (O-RAN), or part thereof. A distributed unit (DU) may also be called remote radio head/remote radio unit/radio equipment/radio unit (RRH/RRU/RE/RU), or part thereof. Hereinafter, in various example embodiments of the present disclosure, a network node, which supports at least one of central unit functionality or a layer 3 protocol of a radio access network, may be, e.g., a gNB-CU. Similarly, a network node, which supports at least one of distributed unit functionality or a layer 2 protocol of the radio access network, may be, e.g., a gNB-DU.

A gNB-CU may support one or multiple gNB-DUs. A gNB-DU may support one or multiple cells and, thus, could support a serving cell for a user equipment (UE) or support a candidate cell for handover, dual connectivity, and/or carrier aggregation, among other procedures.

The user equipment (UE) 150 may be or include a wireless or mobile device, an apparatus with a radio interface to interact with a RAN (radio access network), a smartphone, an in-vehicle apparatus, an IoT device, or a M2M device, among other types of user equipment. Such UE 150 may include: at least one processor; and at least one memory including program code; where the at least one memory and the computer program code are configured to, with the at least one processor, cause the apparatus at least to perform certain operations, such as, e.g., RRC connection to the RAN. An example of components of a UE will be described in connection with FIG. 7. In embodiments, the UE 150 may be configured to generate a message (e.g., including a cell ID) to be transmitted via radio towards a RAN (e.g., to reach and communicate with a serving cell). In embodiments, the UE 150 may generate and transmit and receive RRC messages containing one or more RRC PDUs (packet data units). Persons skilled in the art will understand RRC protocol as well as other procedures a UE may perform.

With continuing reference to FIG. 1, in the example of a 5G NR network, the network system 100 provides one or more cells, which define a coverage area of the network system 100. As described above, the network system 100 may include a gNB of a 5G NR network or may include any other apparatus configured to control radio communication and manage radio resources within a cell. As used herein, the term “resource” may refer to radio resources, such as a resource block (RB), a physical resource block (PRB), a radio frame, a subframe, a time slot, a sub-band, a frequency region, a sub-carrier, a beam, etc. In embodiments, the network node 120 may be called a base station.

FIG. 1 provides an example and is merely illustrative of a network system 100 and a UE 150. Persons skilled in the art will understand that the network system 100 includes components not illustrated in FIG. 1 and will understand that other user equipment may be in communication with the network system 100.

FIG. 2 is a block diagram of example components of the network system 100 of FIG. 1. A 5G NR network may be described as an example of the network system 100, and it is intended that aspects of the following description shall be applicable to other types of network systems, as well. The network system may operate in accordance with the signals and connections shown in FIG. 1 such that the UE 150 is in communication with the network system 100 through the radio access network (RAN) 225. Additionally, the network system may be divided into user plane components and functions and control plane components and functions, as shown and described herein. Unless indicated otherwise, the terms “component”, “function”, and “service” may be used interchangeably herein, and they may refer to and be implemented by instructions executed by one or more processors.

Example functions of the components are described below. The example functions are merely illustrative, and it shall be understood that additional operations and functions may be performed by the components described herein. Additionally, the connections between components may be virtual connections over service-based interfaces such that any component may communicate with any other component. In this manner, any component may act as a service “producer,” for any other component that is a service “consumer,” to provide services for network functions.

For example, a core network 210 is described in the control plane of the network system. The core network 210 may include an authentication server function (AUSF) 211, an access and mobility management function (AMF) 212, and a session management function (SMF) 213. The core network 210 may also include a network slice selection function (NSSF) 214, a network exposure function (NEF) 215, a network repository function (NRF) 216, and a unified data management function (UDM) 217, which may include a uniform data repository (UDR) 224.

Additional components and functions of the core network 210 may include an application function (AF) 218, policy control function (PCF) 219, network data analytics function (NWDAF) 220, analytics data repository function (ADRF) 221, management data analytics function (MDAF) 222, and operations and management function (OAM) 223.

The user plane includes the UE 150, a radio access network (RAN) 225, a user plane function (UPF) 226, and a data network (DN) 227. The RAN 225 may include one or more components described in connection with FIG. 1, such as one or more network nodes. However, the RAN 225 may not be limited to such components. The UPF 226 provides connection for data being transmitted over the RAN 225. The UPF 226 identifies services from service providers, Internet access, and third party services, for example.

The AMF 212 processes connection and mobility tasks. The AUSF 211 receives authentication requests from the AMF 212 and interacts with UDM 217 to authenticate and validate network responses for determination of successful authentication. The SMF 213 conducts packet data unit (PDU) session management, as well as manages session context with the UPF 226.

The NSSF 214 may select a network slicing instance (NSI) and determine the allowed network slice selection assistance information (NSSAI). This selection and determination is utilized to set the AMF 212 to provide service to the UE 150. The NEF 215 secures access to network services for third parties to create specialized network services. The NRF 216 acts as a repository to store network functions to allow the functions to register with and discover each other.

The UDM 217 generates authentication vectors for use by the AUSF 211 and AMF 212 and provides user identification handling. The UDM 217 may be connected to the UDR 224 which stores data associated with authentication, applications, or the like. The AF 218 provides application services to a user (e.g., streaming services, etc.). The PCF 219 provides policy control functionality. For example, the PCF 219 may assist in network slicing and mobility management, as well as provide quality of service (QoS) and charging functionality.

The NWDAF 220 collects data (e.g., from the UE 150 and the network system) to perform network analytics and provide insight to functions that utilize the analytics in the providing of services. The ADRF 221 allows the storage, retrieval, and removal of data and analytics by consumers. The MDAF 222 provides additional data analytics services for network functions. The OAM 223 provides provisioning and management processing functions to manage elements in or connected to the network (e.g., UE 150, network nodes, etc.).

FIG. 2 is merely an example of components of a network system, and variations are contemplated to be within the scope of the present disclosure. In embodiments, the network system may include other components not illustrated in FIG. 2. In embodiments, the network system may not include every component illustrated in FIG. 2. In embodiments, the components and connections may be implemented with different connections than those illustrated in FIG. 2. Such and other embodiments are contemplated to be within the scope of the present disclosure.

Determination of location coordinates by a requesting entity, for example, a Location Management Function (LMF), depends on accurate detection of a first signal path and resolution of potential multi-path components. However, providing excessive samples provides the technical problem of failing to enhance positioning accuracy and incurring substantial overhead and power consumption, particularly if key signal paths are already well-identified.

The present disclosure provides the technical solution of a reporting entity dynamically switching between Type-A (path-based) reporting and Type-B (sample-based) reporting based on network configurations, threshold indications, and measurements, thus allowing a requesting entity using an Artificial Intelligence/Machine Learning (AI/ML) functionality to accurately estimate location coordinates without excessive signaling and/or reporting. Path-based measurements (e.g., Type-A measurements) focus on identifying and reporting specific signal paths, particularly a first path and any additional paths detected during channel measurement. Sample-based measurements (e.g., Type-B measurements), rather than focusing on specific paths, instead focus on capturing time domain samples of a channel impulse response. Sample-based measurements, in contrast to path-based measurements, offer a more granular representation of the channel by capturing sequential time domain samples. By the technical solution of the present disclosure, which adaptively switches between path-based reporting and sample-based reporting depending upon channel conditions and measurements, both positioning accuracy and system efficiency are ultimately improved.

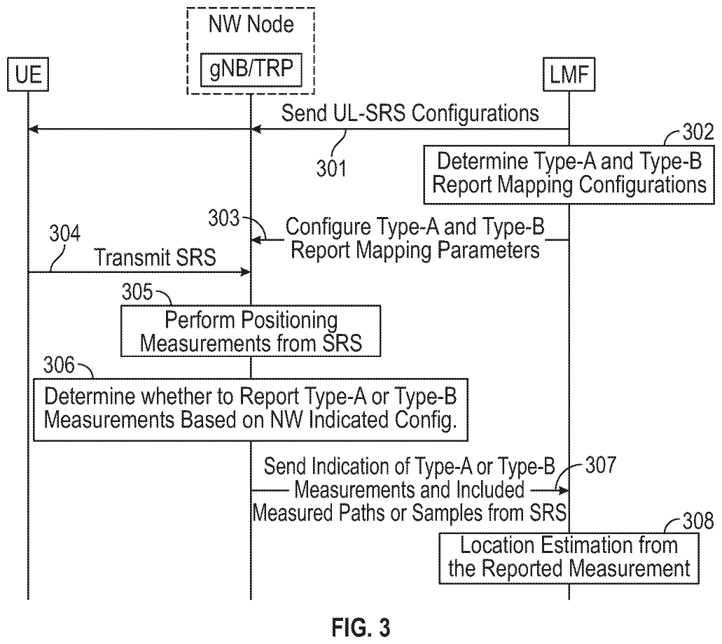

FIG. 3 is a flow diagram illustrating a method for a reporting entity, such as a network node, autonomously determining to report path-based (e.g., Type-A) measurements or sample-based (e.g., Type-B) measurements to a requesting entity, such as a Location Management Function (LMF), which provides a location estimate based on the reported measurements. The operations are performed by the components shown at the top of FIG. 3, which include a user equipment (UE), a network node, and an LMF. The network node may be a gNodeB (gNB) or a Transmission-Reception Point (TRP). Such components may be, for example, the same components described in connection with FIG. 1 and FIG. 2 or otherwise described above.

At operation 301, an LMF transmits uplink (UL)-Sounding Reference Signal (SRS) configurations to a network node, and the network node receives the UL-SRS configurations from the LMF. Also at operation 301, the network node transmits UL-SRS configurations to a UE, and the UE receives the UL-SRS configurations from the network node. Prior to the transmitting, the LMF determines and configures the UL-SRS for positioning.

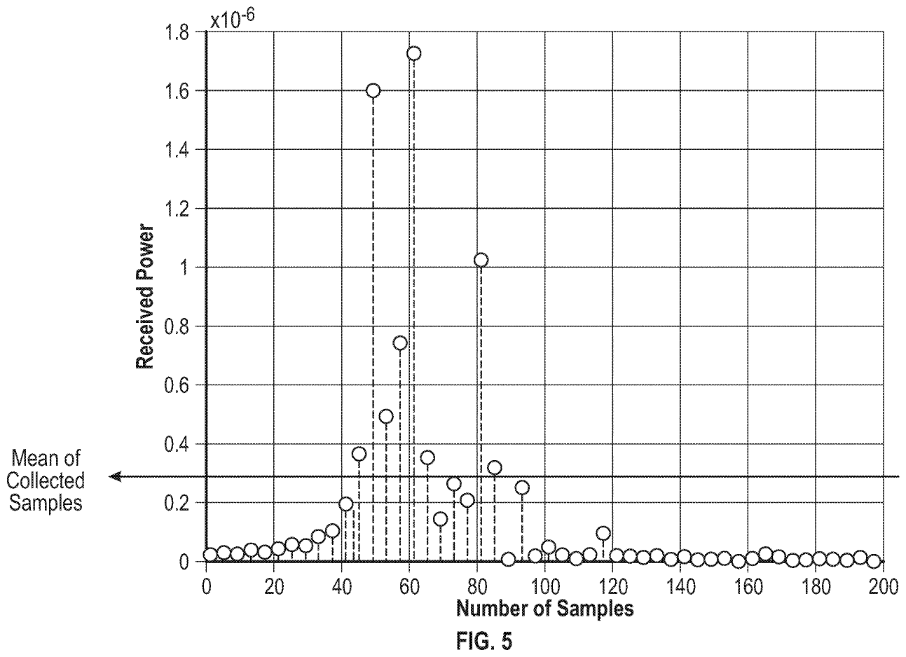

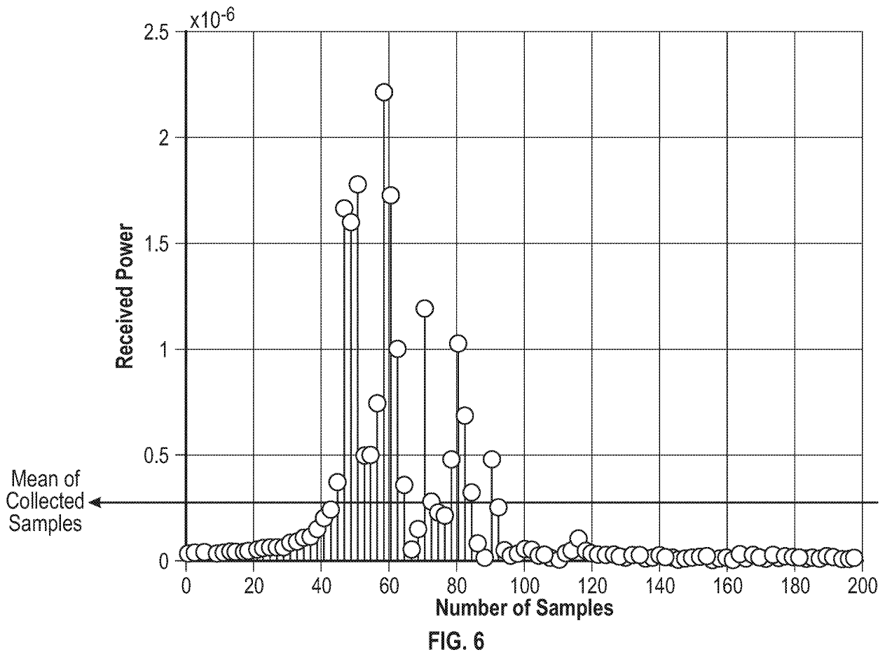

At operation 302, the LMF determines path-based configurations and sample-based configurations (e.g., Type-A and Type-B report mapping configurations/parameters). The path-based configurations and sample-based configurations concern report mapping, and may be based upon a threshold indication, thus enabling the LMF to preemptively configure whether a reporting entity, for FIG. 3, a network node, should report aggregated path measurements, such as path power or path delay, or sampled measurements, such as sample power or sample delay. The LMF may determine the threshold indication (shown, for example, in FIGS. 5 and 6). The threshold indication may include a ratio, a difference, a number of detected paths, or the like. In aspects, for power-based measurements, such as UL-SRS sample power, the threshold indication may include a mean-to-max ratio, a median-to-max ratio, and/or a delta. The mean-to-max ratio may be a ratio of a strongest received signal power of a first path of the UL-SRS and an average received signal power of the UL-SRS. The median-to-max ratio may be a ratio of the strongest received signal power of the first path of the UL-SRS and a median received signal power of the UL-SRS. The delta may be a ratio of the strongest received signal power of the first path of the UL-SRS and a strongest received signal power of a second path of the UL-SRS. In further aspects, for time-based measurements, such as UL Relative Time of Arrival (RTOA) and Multi-Round-Trip-Time (Multi-RTT), the threshold indication may include a mean-to-first delay ratio, a median-to-first delay ratio, and/or a delta delay ratio. The mean-to-first delay ratio may be a ratio of a first path delay of the UL-SRS and an average delay of the UL-SRS. The median-to-first delay ratio may be a ratio of the first path delay of the UL-SRS to a median delay of the UL-SRS. The delta delay ratio may be a ratio of the first path delay of the UL-SRS to a second path delay of the UL-SRS.

At operation 303, the LMF determines a path-based configuration and a sample-based configuration and transmits the path-based configuration and the sample-based configuration to the network node. The network node receives the path-based configuration and the sample-based configuration from the LMF. Further, the LMF may transmit the threshold indication to the network node and the network node may receive the threshold indication from the LMF. The LMF may additionally configure report periodicity, methods, and resources for reporting to the network node, and the network node may receive the report periodicity, methods, and resources for reporting.

At operation 304, the UE transmits an SRS to the network node, and the network node receives the SRS from the UE. The SRS is transmitted on configured resources.

At operation 305, the network node performs measurements on configured resources, in particular, the network node may perform positioning measurements. The measurements may be performed on the SRS.

At operation 306, the network node generates a measurement report of the measurements from the SRS and determines whether to report path-based measurements or sample-based measurements. The network node may autonomously, adaptively indicate path-based Reference Signal Received Path Power (RSRPP) reporting or sample-based Reference Signal Received Sample Power (RSRSP) reporting based on the received UL-SRS configurations, the received SRS, the received threshold indication, received and/or performed measurements (e.g., measured paths from the SRS and measured samples from the SRS), current channel conditions, and/or a network-indicated configuration including the received path-based configuration or the received sample-based configuration. The measurement report includes measurements, such as path-based measurements and/or sample-based measurements, and may further include an indication of measurement type (e.g., path-based or sample-based). The indication may be an explicit indication, in which the network node explicitly signals the use of path-based measurements or sample-based measurements to the requesting entity (e.g., the LMF). The measurement report in this case includes both the measurement types and the associated measurements. In aspects, the indication may be an implicit indication, in which the network node includes only the associated measurement results in the report without explicitly indicating the measurement types. The requesting entity (e.g., the LMF) determines the use of path-based measurements or sample-based measurements based on the structure or content of the report.

At operation 307, the network node transmits the measurement report to the LMF, and the LMF receives the measurement report from the network node. As stated above, the measurement report may include an indication of measurement type (e.g., path-based measurements or sample-based measurements), as well as associated measurements, such as measured paths from the SRS or measured samples from the SRS.

At operation 308, the LMF performs location estimation, for example, determines location coordinates, from the measurement report using a positioning functionality. The positioning functionality may be a legacy-/AIML-based positioning method which utilizes the reported measurements. The LMF may also use the reported measurements for training, inference, and/or monitoring purposes.

The operations of FIG. 3 are merely examples, and variations are contemplated to be within the scope of the present disclosure. In embodiments, the operations may include others not illustrated in FIG. 3. In embodiments, the operations may not include every operation illustrated in FIG. 3. In embodiments, the operations may be implemented in a different order than that illustrated in FIG. 3. Such and other embodiments are contemplated to be within the scope of the present disclosure. Persons of skill in the art will appreciate that, although various example components are described as performing various functions, other components may perform those functions described in FIG. 3.

The following describes operations from the perspective of a network node. From such a perspective, a method may include: receiving, by a network node from a Location Management Function (LMF), at least one of a path-based configuration or a sample-based configuration for determining positioning measurements to be used by an Artificial Intelligence/Machine Learning (AIML) functionality (e.g., FIG. 3, operation 303); receiving, by the network node from a user equipment (UE), a Sounding Reference Signal (SRS) (e.g., FIG. 3, operation 304); performing, by the network node, the positioning measurements based on the SRS (e.g., FIG. 3, operation 305); generating, by the network node, a measurement report based on the positioning measurements (e.g., FIG. 3, operation 306); and transmitting, by the network node to the LMF, the measurement report (e.g., FIG. 3, operation 307).

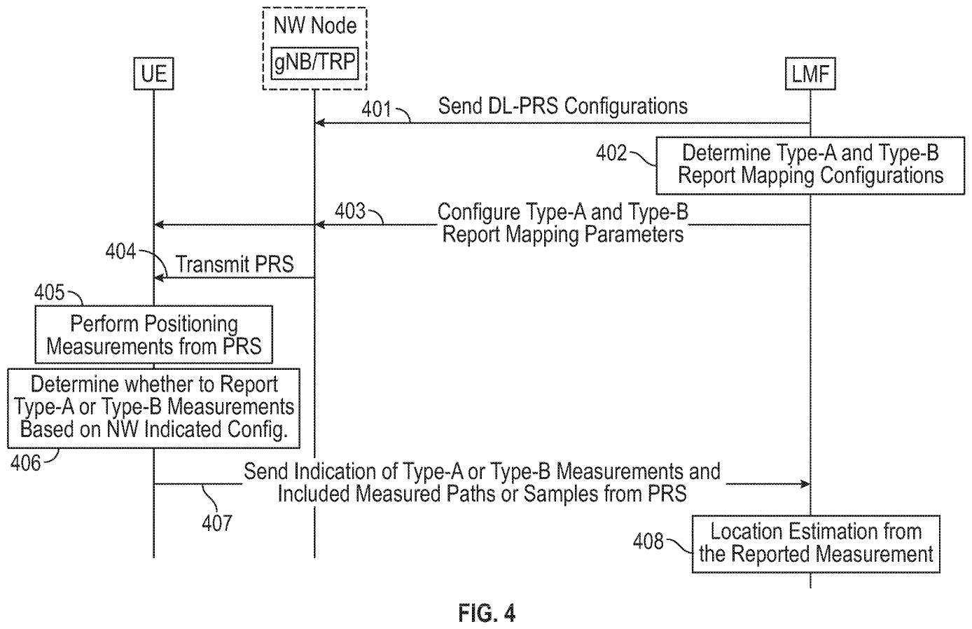

FIG. 4 is a flow diagram illustrating a method for a reporting entity, such as a UE, autonomously determining to report path-based (e.g., Type-A) measurements or sample-based (e.g., Type-B) measurements to a requesting entity, such as an LMF, which provides a location estimate based on the reported measurements. The operations are performed by the components shown at the top of FIG. 4, which include a UE, a network node, and an LMF. The network node may be a gNB or a TRP. Such components may be, for example, the same components described in connection with FIG. 1 and FIG. 2 or otherwise described above.

At operation 401, an LMF transmits downlink (DL)-Positioning Reference Signal (PRS) configurations to a network node, and the network node receives the DL-PRS configurations from the LMF. Prior to the transmitting, the LMF determines and configures the DL-PRS for positioning.

At operation 402, the LMF determines path-based configurations and sample-based configurations (e.g., Type-A and Type-B report mapping configurations/parameters). The path-based configurations and sample-based configurations concern report mapping, and may be based upon a threshold indication, thus enabling the LMF to preemptively configure whether a reporting entity, for FIG. 4, a UE, should report aggregated path measurements, such as path power or path delay, or sampled measurements, such as sample power or sample delay. The LMF may determine the threshold indication. The threshold indication may include a ratio, a difference, a number of detected paths, or the like. In aspects, for power-based measurements, such as DL-PRS path power, the threshold indication may include a mean-to-max ratio, a median-to-max ratio, and/or a delta. The mean-to-max ratio may be a ratio of a strongest received signal power of a first path of the DL-PRS and an average received signal power of the DL-PRS. The median-to-max ratio may be a ratio of the strongest received signal power of the first path of the DL-PRS and a median received signal power of the DL-PRS. The delta may be a ratio of the strongest received signal power of the first path of the DL-PRS and a strongest received signal power of a second path of the DL-PRS. In further aspects, for time-based measurements, such as UL RTOA and Multi-RTT, the threshold indication may include a mean-to-first delay ratio, a median-to-first delay ratio, and/or a delta delay ratio. The mean-to-first delay ratio may be a ratio of a first path delay of the DL-PRS and an average delay of the DL-PRS. The median-to-first delay ratio may be a ratio of the first path delay of the DL-PRS to a median delay of the DL-PRS. The delta delay ratio may be a ratio of the first path delay of the DL-PRS to a second path delay of the DL-PRS.

At operation 403, the LMF determines a path-based configuration and a sample-based configuration and transmits the path-based configuration and the sample-based configuration to the network node. The network node receives the path-based configuration and the sample-based configuration from the LMF. Further, the LMF may transmit the threshold indication to the network node and the network node may receive the threshold indication from the LMF. The LMF may additionally configure report periodicity, methods, and resources for reporting to the network node, and the network node may receive the report periodicity, methods, and resources for reporting.

Also at operation 403, the network node transmits the path-based configuration and the sample-based configuration to the UE, and the UE receives the path-based configuration and the sample-based configuration from the network node. The network node may also transmit the threshold indication to the UE and the UE may receive the threshold indication from the network node. Additionally, the network node may transmit the report periodicity, methods, and resources for reporting to the UE, and the UE may receive the report periodicity, methods, and resources for reporting.

At operation 404, the network node transmits a PRS to the UE, and the UE receives the PRS from the network node. The PRS is transmitted on configured resources.

At operation 405, the UE performs measurements on configured resources, in particular, the UE may perform positioning measurements. The measurements may be performed on the PRS.

At operation 406, the UE generates a measurement report of the measurements from the PRS and determines whether to report path-based measurements or sample-based measurements. The UE may autonomously, adaptively indicate path-based RSRPP reporting or sample-based RSRSP reporting based on the received DL-PRS configurations, the received PRS, the received threshold indication, received and/or performed measurements (e.g., measured paths from the PRS and measured samples from the PRS), current channel conditions, and/or a network-indicated configuration including the received path-based configuration or the received sample-based configuration. As discussed with reference to FIG. 3, the measurement report includes measurements, such as path-based measurements and/or sample-based measurements, and may further include an indication of measurement type (e.g., path-based or sample-based). The indication may be an explicit indication, in which the UE explicitly signals the use of path-based measurements or sample-based measurements to the requesting entity (e.g., the LMF). For an explicit indication, the measurement report includes both the measurement types and the associated measurements. The indication may be an implicit indication, in which the UE includes only the associated measurement results in the report without explicitly indicating the measurement types. The requesting entity (e.g., the LMF) determines the use of path-based measurements or sample-based measurements based on the structure or content of the report.

At operation 407, the UE transmits the measurement report to the LMF, and the LMF receives the measurement report from the UE. As stated above, the measurement report may include an indication of measurement type (e.g., path-based measurements or sample-based measurements), as well as associated measurements, such as measured paths from the PRS or measured samples from the PRS.

At operation 408, the LMF performs location estimation from the measurement report using a localization functionality. For example, the LMF may determine location coordinates using the measurement report and the localization functionality. The localization functionality may be a legacy-/AIML-based positioning method which utilizes the reported measurements. The LMF may also use the reported measurements for training, inference, and/or monitoring purposes.

The operations of FIG. 4 are merely examples, and variations are contemplated to be within the scope of the present disclosure. In embodiments, the operations may include others not illustrated in FIG. 4. In embodiments, the operations may not include every operation illustrated in FIG. 4. In embodiments, the operations may be implemented in a different order than that illustrated in FIG. 4. Such and other embodiments are contemplated to be within the scope of the present disclosure. Persons of skill in the art will appreciate that, although various example components are described as performing various functions, other components may perform those functions described in FIG. 4.

The following describes operations from the perspective of a user equipment (UE). From such a perspective, a method may include: receiving, by a user equipment (UE) from a network node, at least one of a path-based configuration or a sample-based configuration for determining positioning measurements to be used by at least an Artificial Intelligence/Machine Learning (AIML) functionality (e.g., FIG. 4, operation 403); receiving, by the UE from the network node, a Position Reference Signal (PRS) (e.g., FIG. 4, operation 404); performing, by the UE, the positioning measurements based on the PRS (e.g., FIG. 4, operation 405); generating, by the UE, a measurement report based on the positioning measurements (e.g., FIG. 4, operation 406); and transmitting, by the UE to a Location Management Function (LMF), the measurement report (e.g., FIG. 4, operation 407).

The following describes operations from the perspective of a Location Management Function (LMF). From such a perspective, a method may include: determining, by a Location Management Function (LMF), at least one of a path-based configuration or a sample-based configuration for determining measurements to be used by at least an Artificial Intelligence/Machine Learning (AIML) functionality (e.g., FIG. 4, operation 402); configuring, by the LMF to a network node, the at least one of the path-based configuration or the sample-based configuration (e.g., FIG. 4, operation 403); and receiving, by the LMF from a user equipment (UE), a measurement report (e.g., FIG. 4, operation 407).

FIG. 5 illustrates a chart showing an example in which path-based reporting is determined to be used by a reporting entity, for example, a UE or a network node. To determine whether a first path and potential multi-path components are identified, and therefore, determine that path-based reporting should be used, the reporting entity calculates a value that is the same type as the threshold indication configured by the requesting entity, for example, the LMF, in operation 303 or operation 403. For example, the threshold indication may be the mean-to-max ratio, the median-to max ratio, the delta, the mean-to-first delay ratio, the median-to-first delay ratio, the delta delay ratio, the number of detected paths, and/or any other suitable threshold indication type. If the calculated value is greater than the threshold indication, the reporting entity determines to use path-based reporting.

FIG. 5 shows a general impulse response having 200 samples. As shown in FIG. 5, the threshold indication is denoted by the line indicating a mean of collected samples. As shown, line of sight (LoS) and non-line of sight (NLoS) components are well-established. Since the first path and potential multi-path components are clearly identified, to conserve reporting overhead and prevent decreasing measurement accuracy, path-based RSRPP reporting is used.

FIG. 6 illustrates a chart showing an example in which sample-based reporting is determined to be used by a reporting entity, such as a UE or a network node. To determine whether a first path and potential multi-path components are identified, the same method as described with reference to FIG. 5 is used. However, here, if a value calculated by the reporting entity is smaller than or equal to the threshold indication, the reporting entity determines to use sample-based reporting.

Similar to FIG. 5, FIG. 6 shows a general impulse response having 200 samples. The threshold indication is again denoted by the line indicating a mean of collected samples. However, unlike FIG. 5, as shown in FIG. 6, the first path and potential multi-path components are difficult to separate due to dense multi-path environments. Therefore, to conserve reporting overheard, sample-based RSRSP reporting is used. To further ensure efficient data collection without excessive reporting, a granularity configuration (e.g., reporting every second, fourth, or eighth sample) may be dynamically adjusted based on channel dynamics.

FIG. 7 is a block diagram of a wireless station or node (e.g., UE, user device, AP, BS, eNB, gNB, RAN node, network node, transmission reception point (TRP), or other node) 700, according to one illustrated aspect of the present disclosure. The wireless station 700 may include, for example, one or more (e.g., two as shown in FIG. 7) RF (radio frequency) or wireless transceivers 702A, 702B, where each wireless transceiver includes a transmitter to transmit signals and a receiver to receive signals. The wireless station also includes a processor or control unit/entity (controller) 708 to execute instructions or software and control transmission and receptions of signals, and a memory 706 to store data and/or instructions.

Processor 704 may also make decisions or determinations, generate frames, packets or messages for transmission, decode received frames or messages for further processing, and other tasks or functions described herein. Processor 704, which may be a baseband processor, for example, may generate messages, packets, frames, or other signals for transmission via wireless transceiver 702 (702A or 702B). Processor 704 may control transmission of signals or messages over a wireless network and may control the reception of signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller (or processor) 708 may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

According to another example embodiment, RF or wireless transceiver(s) 702A/702B may receive signals or data and/or transmit or send signals or data. Processor 704 (and possibly transceivers 702A/702B) may control the RF or wireless transceiver 702A or 702B to receive, send, broadcast or transmit signals or data.

Example embodiments are provided or described for each of the example methods, including: An apparatus (e.g., 700, FIG. 7) including means (e.g., processor 704, RF transceivers 702A and/or 702B, and/or memory 706, in FIG. 7) for carrying out any of the methods; a non-transitory computer-readable storage medium (e.g., memory 706, FIG. 7) comprising instructions stored thereon that, when executed by at least one processor (processor 704, FIG. 7), are configured to cause a computing system (e.g., 700, FIG. 7) to perform any of the example methods; and an apparatus (e.g., 700, FIG. 7) including at least one processor (e.g., processor 704, FIG. 7), and at least one memory (e.g., memory 706, FIG. 7) including computer program code, the at least one memory (706) and the computer program code configured to, with the at least one processor (704), cause the apparatus (e.g., 700) at least to perform any of the example methods.

Further embodiments of the present disclosure include the following examples.

Example 1.1 A method, comprising:
receiving, by a user equipment (UE) from a network node, at least one of a path-based configuration or a sample-based configuration for determining positioning measurements to be used by at least an Artificial Intelligence/Machine Learning (AIML) functionality;
receiving, by the UE from the network node, a Position Reference Signal (PRS);
performing, by the UE, the positioning measurements based on the PRS;
generating, by the UE, a measurement report based on the positioning measurements; and
transmitting, by the UE to a Location Management Function (LMF), the measurement report.

Example 1.2 The method of Example 1.1, further comprising, prior to generating the measurement report:
determining, by the UE, to report at least one of path-based measurements or sample-based measurements based on at least one of the path-based configuration or the sample-based configuration.

Example 1.3 The method of any one of Example 1.1 or Example 1.2, wherein the transmitting includes an indication of path-based measurements or sample-based measurements from the PRS.

Example 1.4 The method of Example 1.1, wherein the transmitting includes only the positioning measurements in the measurement report without explicitly indicating a measurement type.

Example 1.5 The method of Example 1.3, wherein the path-based measurements include measured paths, and
wherein the sample-based measurements include measured samples.

Example 1.6 The method of any one of Examples 1.1 to 1.5, wherein the at least one of the path-based configuration or the sample-based configuration includes a threshold indication.

Example 1.7 The method of Example 1.6, wherein the threshold indication includes at least one of the following:
a mean-to-max ratio, wherein the mean-to-max ratio is a ratio of a strongest received signal power of a first path of the PRS and an average received signal power of the PRS;
a median-to-max ratio, wherein the median-to-max ratio is a ratio of the strongest received signal power of the first path of the PRS and a median received signal power of the PRS;
a delta, wherein the delta is a ratio of the strongest received signal power of the first path of the PRS and a strongest received signal power of a second path of the PRS;
a mean-to-first delay ratio, wherein the mean-to-first delay ratio is a ratio of a delay of the first path of the PRS and an average delay of the PRS;
a median-to-first delay ratio, wherein the median-to-first delay ratio is a ratio of the delay of the first path of the PRS and a median delay of the PRS; or
a delta delay ratio, wherein the delta delay ratio is a ratio of the delay of the first path of the PRS and a delay of the second path of the PRS.

Example 1.10 A method, comprising:
determining, by a Location Management Function (LMF), at least one of a path-based configuration or a sample-based configuration for determining measurements to be used by at least an Artificial Intelligence/Machine Learning (AIML) functionality;
configuring, by the LMF to a network node, the at least one of the path-based configuration or the sample-based configuration; and
receiving, by the LMF from a user equipment (UE), a measurement report.

Example 1.11 The method of Example 1.10, further comprising, prior to determining the at least one of the path-based configuration or the sample-based configuration:
configuring, by the LMF to the network node, a downlink (DL) Position Reference Signal (PRS) configuration for positioning.

Example 1.12 The method of any one of Example 1.10 or Example 1.11, wherein the measurement report includes an indication of path-based measurements or sample-based measurements from a PRS.

Example 1.13 The method of any one of Example 1.10 or Example 1.11, wherein the measurement report includes only positioning measurements based on the PRS without explicitly indicating a measurement type.

Example 1.14 The method of Example 1.12, wherein the path-based measurements include measured paths, and
wherein the sample-based measurements include measured samples.

Example 1.15 The method of any one of Example 1.12 or Example 1.13, further comprising:
determining, by the LMF using the AIML functionality, location coordinates using the measurement report.

Example 1.16 The method of any one of Examples 1.10 to 1.15, wherein at least one of the path-based configuration or the sample-based configuration includes a threshold indication.

Example 1.17 The method of Example 1.16, wherein the threshold indication includes at least one of the following:
a mean-to-max ratio, wherein the mean-to-max ratio is a ratio of a strongest received signal power of a first path of a PRS and an average received signal power of the PRS;
a median-to-max ratio, wherein the median-to-max ratio is a ratio of the strongest received signal power of the first path of the PRS and a median received signal power of the PRS;
a delta, wherein the delta is a ratio of the strongest received signal power of the first path of the PRS and a strongest received signal power of a second path of the PRS;
a mean-to-first delay ratio, wherein the mean-to-first delay ratio is a ratio of a delay of the first path of the PRS and an average delay of the PRS;
a median-to-first delay ratio, wherein the median-to-first delay ratio is a ratio of the delay of the first path of the PRS and a median delay of the PRS; or
a delta delay ratio, wherein the delta delay ratio is a ratio of the delay of the first path of the PRS and a delay of the second path of the PRS.

Example 1.18 The method of Example 1.10, further comprising:
determining, by the LMF, a use of path-based measurements and sample-based measurements based on at least one of a structure or content of the measurement report.

Example 1.21 A method, comprising:
receiving, by a network node from a Location Management Function (LMF), at least one of a path-based configuration or a sample-based configuration for determining positioning measurements to be used by an Artificial Intelligence/Machine Learning (AIML) functionality;
receiving, by the network node from a user equipment (UE), a Sounding Reference Signal (SRS);
performing, by the network node, the positioning measurements based on the SRS;
generating, by the network node, a measurement report based on the positioning measurements; and
transmitting, by the network node to the LMF, the measurement report.

Example 1.22 The method of Example 1.21, further comprising, prior to receiving the at least one of the path-based configuration or the sample-based configuration:
receiving, by the network node from the LMF, an uplink (UL) SRS configuration for positioning; and
transmitting, by the network node to the UE, the uplink SRS configuration.

Example 1.23 The method of any one of Example 1.21 or Example 1.22, further comprising, prior to generating the measurement report:
determining, by the network node, to report at least one of path-based measurements or sample-based measurements based on at the least one of the path-based configuration or the sample-based configuration.

Example 1.24 The method of any one of Examples 1.21 to 1.23, wherein the measurement report includes an indication of path-based measurements or sample-based measurements from the SRS.

Example 1.25 The method of Example 1.21, wherein the measurement report includes only the positioning measurements in the measurement report without explicitly indicating a measurement type.

Example 1.26 The method of Example 1.24, wherein the path-based measurements include measured paths, and
wherein the sample-based measurements include measured samples.

Example 1.27 The method of any one of Examples 1.21 to 1.26, wherein the at least one of the path-based configuration or the sample-based configuration includes a threshold indication.

Example 1.28 The method of Example 1.27, wherein the threshold indication includes at least one of the following:
a mean-to-max ratio, wherein the mean-to-max ratio is a ratio of a strongest received signal power of a first path of the SRS and an average received signal power of the SRS;
a median-to-max ratio, wherein the median-to-max ratio is a ratio of the strongest received signal power of the first path of the SRS and a median received signal power of the SRS;
a delta, wherein the delta is a ratio of the strongest received signal power of the first path of the SRS and a strongest received signal power of a second path of the SRS;
a mean-to-first delay ratio, wherein the mean-to-first delay ratio is a ratio of a delay of the first path of the SRS and an average delay of the SRS;
a median-to-first delay ratio, wherein the median-to-first delay ratio is a ratio of the delay of the first path of the SRS and a median delay of the SRS; or
a delta delay ratio, wherein the delta delay ratio is a ratio of the delay of the first path of the SRS and a delay of the second path of the SRS.

The preceding Examples may be implemented in algorithm(s), encoded in a distribution medium or computer program product(s), and as method(s) performed by apparatus(es). An apparatus may comprise means for causing the apparatus at least to perform the method(s). The means may comprise at least one processor; and at least one memory storing algorithm as instructions that, when executed by the at least one processor, cause the apparatus at least to perform the method(s).

The embodiments and aspects disclosed herein are examples of the present disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with this present disclosure. The phrase “a plurality of” may refer to two or more.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

While aspects of the present disclosure have been shown in the drawings, it is not intended that the present disclosure be limited thereto, as it is intended that the present disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A network apparatus, comprising:
at least one processor; and
at least one memory storing instructions which, when executed by the at least one processor, cause the network apparatus at least to perform:
receiving, from a Location Management Function (LMF), at least one of a path-based configuration or a sample-based configuration for determining positioning measurements to be used by an Artificial Intelligence/Machine Learning functionality;
receiving, from a user equipment (UE), a Sounding Reference Signal (SRS);
performing the positioning measurements based on the SRS;
generating a measurement report based on the positioning measurements; and
transmitting to the LMF, the measurement report.

2. The network apparatus of claim 1, further caused to perform prior to receiving the at least one of the path-based configuration or the sample-based configuration:
receiving, from the LMF, an uplink SRS configuration for positioning; and
transmitting, to the UE, the uplink SRS configuration.

3. The network apparatus of claim 1, further caused to perform prior to generating the measurement report:
determining to report at least one of path-based measurements or sample-based measurements based on at the least one of the path-based configuration or the sample-based configuration.

4. The network apparatus of claim 1, wherein the measurement report includes an indication of path-based measurements or sample-based measurements from the SRS.

5. The network apparatus of claim 4, wherein the path-based measurements include measured paths, and
wherein the sample-based measurements include measured samples.

6. The network apparatus of claim 1, wherein the measurement report includes only the positioning measurements in the measurement report without explicitly indicating a measurement type.

7. The network apparatus of claim 1, wherein the at least one of the path-based configuration or the sample-based configuration includes a threshold indication.

8. The network apparatus of claim 1, wherein the threshold indication includes at least one of the following:
a mean-to-max ratio, wherein the mean-to-max ratio is a ratio of a strongest received signal power of a first path of the SRS and an average received signal power of the SRS;
a median-to-max ratio, wherein the median-to-max ratio is a ratio of the strongest received signal power of the first path of the SRS and a median received signal power of the SRS;
a delta, wherein the delta is a ratio of the strongest received signal power of the first path of the SRS and a strongest received signal power of a second path of the SRS;
a mean-to-first delay ratio, wherein the mean-to-first delay ratio is a ratio of a delay of the first path of the SRS and an average delay of the SRS;
a median-to-first delay ratio, wherein the median-to-first delay ratio is a ratio of the delay of the first path of the SRS and a median delay of the SRS; or
a delta delay ratio, wherein the delta delay ratio is a ratio of the delay of the first path of the SRS and a delay of the second path of the SRS.

9. A method, comprising:
receiving, by a network node from a Location Management Function (LMF), at least one of a path-based configuration or a sample-based configuration for determining positioning measurements to be used by an Artificial Intelligence/Machine Learning functionality;
receiving, by the network node from a user equipment (UE), a Sounding Reference Signal (SRS);
performing, by the network node, the positioning measurements based on the SRS;
generating, by the network node, a measurement report based on the positioning measurements; and
transmitting, by the network node to the LMF, the measurement report.

10. The method of claim 9, further comprising, prior to receiving the at least one of the path-based configuration or the sample-based configuration:
receiving, by the network node from the LMF, an uplink SRS configuration for positioning; and
transmitting, by the network node to the UE, the uplink SRS configuration.

11. The method of claim 9, further comprising, prior to generating the measurement report:
determining, by the network node, to report at least one of path-based measurements or sample-based measurements based on at the least one of the path-based configuration or the sample-based configuration.

12. The method of claim 9, wherein the measurement report includes an indication of path-based measurements or sample-based measurements from the SRS.

13. The method of claim 12, wherein the path-based measurements include measured paths, and
wherein the sample-based measurements include measured samples.

14. The method of claim 9, wherein the measurement report includes only the positioning measurements in the measurement report without explicitly indicating a measurement type.

15. A network apparatus, supporting a Location Management Function (LMF), comprising:
at least one processor; and
at least one memory storing instructions which, when executed by the at least one processor, cause the network apparatus at least to perform:
determining at least one of a path-based configuration or a sample-based configuration for determining measurements to be used by at least an Artificial Intelligence/Machine Learning functionality;
configuring, to a network node, the at least one of the path-based configuration or the sample-based configuration; and
receiving a measurement report in accordance with the configuration.

16. The network apparatus of claim 15, further caused to perform prior to determining the at least one of the path-based configuration or the sample-based configuration:
configuring, to the network node, a Sounding Reference Signal (SRS) configuration for positioning.

17. The m network apparatus of claim 15, wherein the measurement report includes an indication of path-based measurements or sample-based measurements from a SRS.

18. The network apparatus of claim 17, wherein the path-based measurements include measured paths, and
wherein the sample-based measurements include measured samples.

19. The network apparatus of claim 15, wherein the measurement report includes only positioning measurements based on the SRS without explicitly indicating a measurement type.

20. The network apparatus of claim 15, further caused to perform:
determining, using the AIML functionality, location coordinates using the measurement report.
